(19) United States
(12) Patent Application Publication
(10) Pub. No.: US 2012/0254071 A1
(43) Pub. Date: Oct. 4, 2012

(54) TEXT MINING SYSTEM, TEXT MINING METHOD AND RECORDING MEDIUM

(75) Inventors: Kai Ishikawa, Tokyo (JP); Shinichi Ando, Tokyo (JP); Akihiro Tamura, Tokyo (JP)

(73) Assignee: NEC CORPORATION, Tokyo (JP)

(21) Appl. No.: 13/516,641

(22) PCT Filed: Dec. 15, 2010
(86) PCT No.: PCT/JP10/73060

§ 371 Date: Jun. 15, 2012

(30) Foreign Application Priority Data
Dec. 17, 2009 (JP) 2009-286318

(51) Int. Cl. G06Q 40/00

(52) U.S. Cl. 705/400

(57) ABSTRACT

Disclosed are a text mining system, text mining method, and recording medium for suppressing increase in cost of analysis for an analyst even if, when analyzing a plurality of data to be analyzed, the data are to be integrally analyzed. The text mining system comprises a data set generation unit for generating a data set to be analyzed that includes data to be analyzed that include text data; and a data set search unit for searching for a data set to be analyzed of which the feature representation coverage exceeds a value given beforehand, or the cost of analysis does not exceed a value given beforehand from data sets to be analyzed generated by the data set generation unit; wherein the feature representation coverage is the ratio of the number of feature representations included in a feature representation list which is a group of feature representations, which are representations satisfying predetermined conditions from text data within the data set to be analyzed, to the number of feature representations in all data to be analyzed; and the cost of analysis is defined on the basis of the number of feature representations included in the data set to be analyzed.

### TECHNICAL FIELD

The present invention relates to a text mining system, a text mining method, and a recording medium.

### BACKGROUND ART

An example of a text mining system which is designed to be able to analyze a plurality of data as a target data to be analyzed is described in patent document 1.

Specifically, the target data to be analyzed that is analyzed by this text mining system includes the following data. The data are a plurality of data to be analyzed obtained in different periods for example, “data in April from 2000 to 2009” or the like. Additionally, the data are a plurality of data to be analyzed obtained by various different means for example, a call text of a call center, a response log, an electronic mail, various bulletin board systems (hereinafter, it is referred as a bulletin board) on the web (World Wide Web), questionnaires, and the like. As shown in FIG. 1, this text mining system is composed of an input device 10, an output device 20, a data processing device 30, and a storage device 40.

The storage device 40 is composed of data-to-be-analyzed storage means 41 and feature representation list storage means 42. The data-to-be-analyzed storage means 41 store two or more text data group as the data to be analyzed. The feature representation list storage means 42 store a group of feature representation obtained by the feature representation extraction means and a feature degree thereof as a feature representation list.

The data processing device 30 is composed of feature representation extraction means 31, comparison setting means 32, comparison list display means 33, and comparison feature extraction means 34. The feature representation extraction means 31 extracts the group of the feature representation and the feature degree thereof from each data to be analyzed as the feature representation list. The comparison setting means 32 set a comparison condition based on information inputted by an analyst. The comparison list display means 33 display the feature representation list of the data to be analyzed used for a target of a comparative analysis as the comparison list. The comparison feature extraction means 34 perform the comparative analysis from the comparison list according to the set comparison condition and extract the comparison feature.

The text mining system having such configuration operates as follows. Namely, the feature representation extraction means 31 perform a process for extracting the feature representation from two or more data to be analyzed and makes the feature representation list storage means 42 store the group of the feature representation and the feature degree thereof that are extracted as the feature representation list. Next, when the comparison setting means 32 set the comparison condition based on the information inputted by the analyst, the comparison list display means 33 perform control so that the feature representation list of the data to be analyzed that is used as the target of the analysis is displayed as the comparison list. Further, the comparison feature extraction means 34 operate so as to perform the comparative analysis by using the comparison list according to the comparison condition, extract the comparison feature, and output it.

### PRIOR ART DOCUMENT

### Patent Document

Patent document 1 Japanese Patent Application Laid-Open No. 2005-165754

### DISCLOSURE OF THE INVENTION

### Technical Problem

A system described in the above-mentioned patent document 1 has a problem in which when a plurality of data to be analyzed are analyzed, it is necessary to integrally analyze a plurality of these data and whereby, a cost of analysis performed by the analyst remarkably increases.

Reasons for this are shown below. A first reason is that the analyst has to perform the comparative analysis about a combination of the data to be analyzed in order to integrally analyze the plurality of data to be analyzed. Further, when the analyst performs the analysis by changing the axis of the analysis while performing trial and error, the feature representation list is updated with a change in the axis of the analysis. Therefore, the analyst has to perform the comparative analysis about the combination of the above-mentioned data to be analyzed with each change in the axis of the analysis. A second reason is that time and effort (it is also called as a cost of analysis) required for the entire analysis including trial and error of changing the axis of the analysis increase remarkably.

Accordingly, an object of the present invention is to provide a text mining system in which when analyzing a plurality of data to be analyzed, even when these data are integrally analyzed, increase in the cost of analysis performed by an analyst can be suppressed, a text mining method, and a recording medium.

### Technical Solution

A text mining system of one aspect of the present invention comprises a data set generation unit which generates a data set to be analyzed including data to be analyzed including text data, and a data set search unit which searches for a data set to be analyzed of which a feature representation coverage exceeds a value given beforehand, or the cost of analysis does not exceed a value given beforehand from data sets to be analyzed generated by the data set generation unit; wherein the feature representation coverage is the ratio of the number of feature representations included in a feature representation list which is a group of feature representations, which are representations satisfying predetermined conditions from text data within the data set to be analyzed, to the number of feature representations in all data to be analyzed; and the cost of analysis is defined on the basis of the number of feature representations included in the data set to be analyzed.

A text mining method of one aspect of the present invention includes generating an data set to be analyzed including data to be analyzed including text data, and searching for the data set to be analyzed of which a feature representation coverage exceeds a value given beforehand, or a cost of analysis does not exceed a value given beforehand from the generated data sets to be analyzed; wherein the feature representation coverage is the ratio of the number of feature representations included in a feature representation list which is a group of feature representations which are representations satisfying predetermined conditions from text data within the data set to be analyzed, to the number of feature representations in all data to be analyzed; and the cost of analysis is defined on the basis of the number of feature representations included in the data set to be analyzed.

A recording medium of one aspect of the present invention that records a program which causes a computer to execute a process for generating a data set to be analyzed including data to be analyzed including text data, and a process for searching for a data set to be analyzed of which a feature representation coverage exceeds a value given beforehand, or a cost of analysis does not exceed a value given beforehand from the generated data sets to be analyzed; wherein the feature representation coverage is the ratio of the number of feature representations included in a feature representation list which is a group of feature representations which are representations satisfying predetermined conditions from text data within the data set to be analyzed, to the number of feature representations in all data to be analyzed; and the cost of analysis is defined on the basis of the number of feature representations included in the data set to be analyzed.

### Advantageous Effects

According to the present invention, when a plurality of data to be analyzed is analyzed, even when these data are integrally analyzed, it can be suppressed that the cost of analysis performed by an analyst gets increased.

### BRIEF DESCRIPTIONS OF THE DRAWINGS

FIG. 1 is a block diagram showing an example of a configuration of a text mining system.

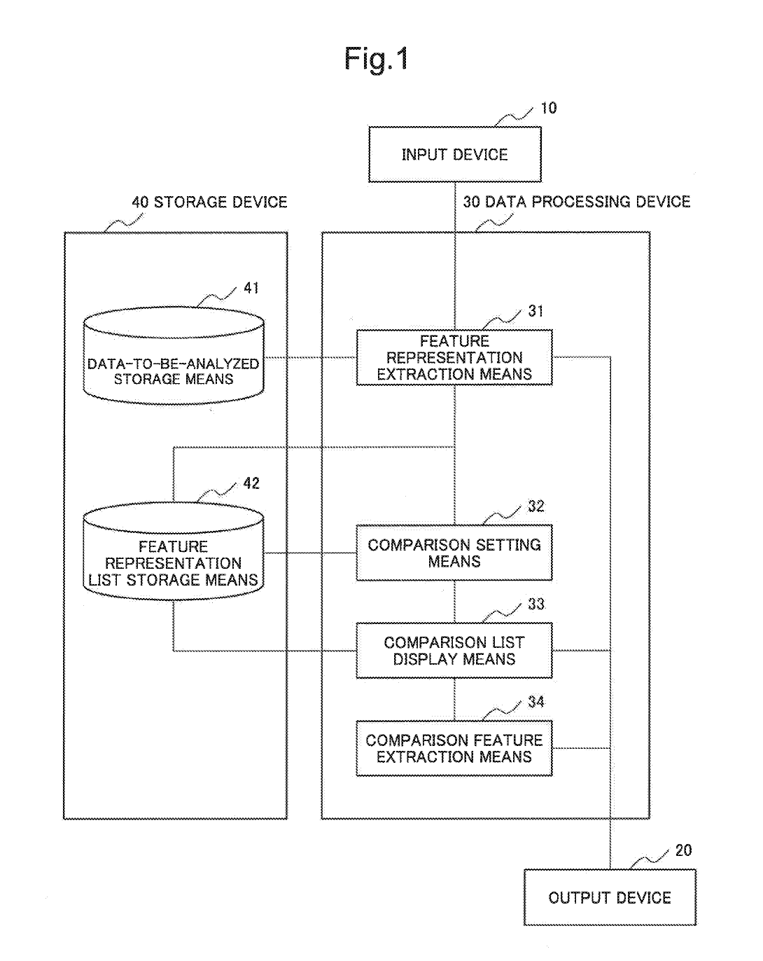

FIG. 2 is a block diagram showing an example of a configuration of a text mining system.

FIG. 3 is a block diagram showing an example of a configuration of a text mining system according to the present invention.

FIG. 4 is a flowchart showing an example of operation performed by a text mining system.

FIG. 5 is an explanatory drawing showing an example of data to be analyzed acquired from a bulletin board A on the Web.

FIG. 6 is an explanatory drawing showing an example of a plurality of data sets to be analyzed acquired by various means.

FIG. 7 is an explanatory drawing showing an example of “the number of representations in the feature representation list” and “cost of analysis per one presentation” for each data to be analyzed.

FIG. 8 is an explanatory drawing showing an example of a possible data set to be analyzed, and a feature representation coverage and a cost of analysis thereof.

FIG. 9 is a functional block diagram showing an example of a minimum functional configuration of a text mining system.

### MODE FOR CARRYING OUT THE INVENTION

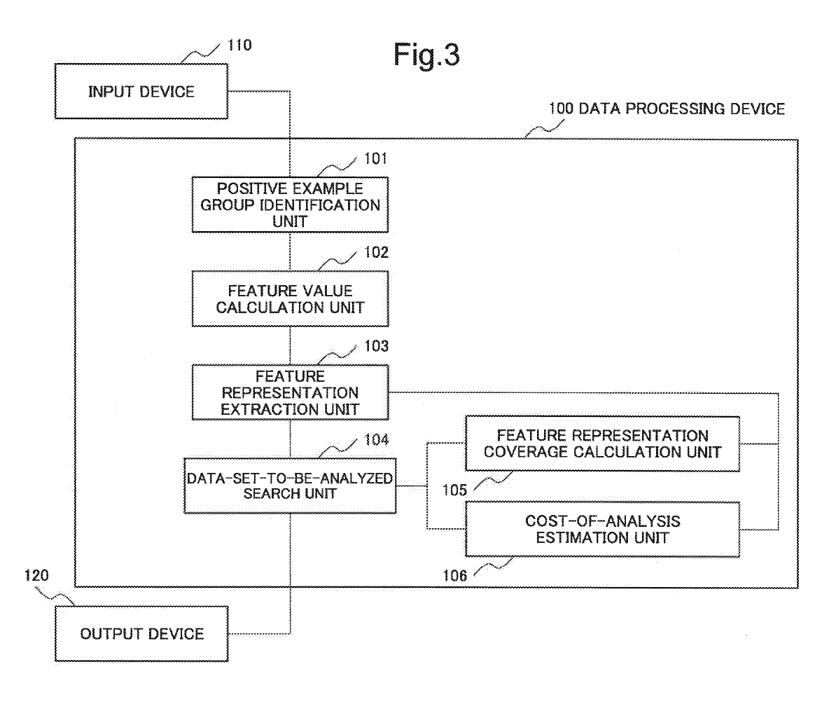

Next, an exemplary embodiment of a text mining system according to the present invention will be described with reference to the drawings. FIG. 3 is a block diagram showing an example of a configuration of a text mining system according to this exemplary embodiment.

Referring to FIG. 3, the text mining system in this exemplary embodiment includes a data processing device 100 (for example, a central processing device or a processor) which operates by program control, an input device 110, and an output device 120.

The data processing device 100 includes a positive example group identification unit 101, a feature value calculation unit 102, a feature representation extraction unit 103, a data-set-to-be-analyzed search unit 104, a feature representation coverage calculation unit 105, and a cost-of-analysis estimation unit 106. These units operate as follows.

Specifically, the positive example group identification unit 101 is realized by a CPU (Central Processing Unit) of an information processing device which operates according to program. The positive example group identification unit 101 has a function to input the axis of the analysis and a plurality of data to be analyzed from the input device 110 and identify a text group of positive examples to the axis of the analysis from each data to be analyzed. Further, the positive example group identification unit 101 has a function to output all text groups of each data to be analyzed and the identified text group of the positive examples to the feature value calculation unit 102. Here, the axis of the analysis represents a viewpoint for the analysis. The text group of positive examples is a group of texts which conforms to the viewpoint indicated by the axis of the analysis.

Specifically, the feature value calculation unit 102 is realized by the CPU of the information processing device which operates according to program. The feature value calculation unit 102 inputs all text groups of each data to be analyzed and the text group of positive examples to the axis of the analysis from the positive example group identification unit 101. The feature value calculation unit 102 has a function to calculate a feature value to the representation from a statistical difference in appearance between all text groups and the text group of positive examples to each representation in the text. Further, the feature value calculation unit 102 has a function to output a group of pairs of the representation and the calculated feature value for each data to be analyzed to the feature representation extraction unit 103.

Specifically, the feature representation extraction unit 103 is realized by the CPU of the information processing device which operates according to program. The feature representation extraction unit 103 has a function to input the group of pairs of the representation and the feature value for each data to be analyzed from the feature value calculation unit 102 and extract the representation having a large feature value as the feature representation for each data to be analyzed. For example, the feature representation extraction unit 103 extracts the representation whose feature value is equal to or greater than a predetermined threshold value, the representation whose feature value is in the top certain percentage, and the like as the representation having a large feature value. Further, the feature representation extraction unit 103 has a function to output a list of the feature representation of each extracted data to be analyzed to the data-set-to-be-analyzed search unit 104, the feature representation coverage calculation unit 105, and the cost-of-analysis estimation unit 106.

Specifically, the data-set-to-be-analyzed search unit 104 is realized by the CPU of the information processing device which operates according to program. The data-set-to-be-analyzed search unit 104 inputs the list of the feature representation of each data to be analyzed from the feature representation extraction unit 103. The data-set-to-be-analyzed search unit 104 has a function to generate a plurality of data sets to be analyzed including one or more data to be analyzed from the plurality of data to be analyzed which is a candidate for a target of analysis. Further, the data-set-to-be-analyzed search unit 104 has a function to output the generated data set to be analyzed to the feature representation coverage calculation unit 105 and the cost-of-analysis estimation unit 106.

Further, the data-set-to-be-analyzed search unit 104 has a function to input the feature representation coverage to the data set to be analyzed from the feature representation coverage calculation unit 105 and input the cost of analysis to the data set to be analyzed from the cost-of-analysis estimation unit 106. Further, specifically, the feature representation coverage indicates a degree of coverage of the feature representation group in all data to be analyzed in the feature representation group in the data set to be analyzed. Further, the data-set-to-be-analyzed search unit 104 searches for the most suitable data set to be analyzed of which the feature representation coverage is high and the cost of analysis is low. The data-set-to-be-analyzed search unit 104 has a function to output the feature representation extracted from the data set to be analyzed that has been searched for to the output device 120 as a mining result.

Specifically, the feature representation coverage calculation unit 105 is realized by the CPU of the information processing device which operates according to program. The feature representation coverage calculation unit 105 has a function to input the list of the feature representation of each data to be analyzed from the feature representation extraction unit 103 and input the data set to be analyzed from the data-set-to-be-analyzed search unit 104. Further, the feature representation coverage calculation unit 105 has a function to calculate the feature representation coverage to the data set to be analyzed from the list of the feature representation to all data to be analyzed and the list of the feature representation to the data set to be analyzed and output the calculated value to the data-set-to-be-analyzed search unit 104.

Specifically, the cost-of-analysis estimation unit 106 is realized by the CPU of the information processing device which operates according to program. The cost-of-analysis estimation unit 106 has a function to input the list of the feature representation of each data to be analyzed from the feature representation extraction unit 103 and input a candidate for the data set to be analyzed from the data-set-to-be-analyzed search unit 104. Further, the cost-of-analysis estimation unit 106 calculates the cost of analysis to the data set to be analyzed from the sum of the costs of analysis in the list of the feature representation to each data to be analyzed included in the data set to be analyzed. The cost-of-analysis estimation unit 106 has a function to output the calculated value to the data-set-to-be-analyzed search unit 104. The cost-of-analysis estimation unit 106 can calculate the cost of analysis of the list of the feature representation by assuming that for example, the cost of analysis is proportional to the number of the feature representations included in the list of the feature representation.

Specifically, the input device 110 is realized by the device such as a keyboard, a mouse, or the like. The input device 110 has a function to input data indicating the viewpoint of the analysis (the axis of the analysis) and the data to be analyzed according to the analyst's operation.

Specifically, the output device 120 is realized by a display device or the like. The output device 120 has a function to display the data outputted by the data-set-to-be-analyzed search unit 104 in a display unit. Further, while the output device 120 displays the data in the display unit in this exemplary embodiment, the output device 120 may have a function to output the data as a file, for example.

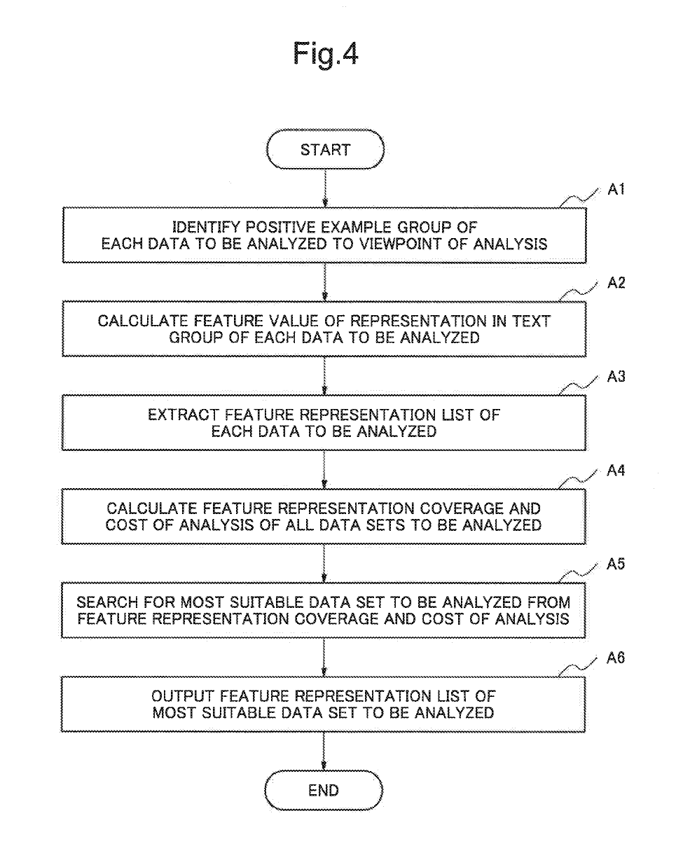

Next, the whole operation of the exemplary embodiment of the present invention will be described with reference to FIG. 3 and FIG. 4. FIG. 4 is a flowchart showing an example of a process performed by the text mining system in the exemplary embodiment.

In order to analyze the predetermined data based on the predetermined viewpoint, when the analyst performs input operation by using the input device 110, the input device 110 inputs the data indicating the viewpoint of the analysis (the axis of the analysis) and a plurality of data to be analyzed according to the operation of the analyst. The positive example group identification unit 101 inputs the data indicating the viewpoint of the analysis (the axis of the analysis) and the plurality of data to be analyzed from the input device 110 and identifies the text group of the positive examples (hereinafter, it is also described as a positive example group) to the axis of the analysis from each data to be analyzed. The positive example group identification unit 101 outputs the whole text group of each data to be analyzed and the text group of the positive examples that is identified to the feature value calculation unit 102 (step A1 of FIG. 4).

Next, the feature value calculation unit 102 inputs all text groups of each data to be analyzed and the text group of the positive examples to the axis of the analysis from the positive example group identification unit 101. The feature value calculation unit 102 calculates the feature value to the representation from the statistical difference in appearance between all text groups and the text group of the positive examples to each representation in the text. The feature value calculation unit 102 outputs the group of the pairs of the representation and the calculated feature value for each data to be analyzed to the feature representation extraction unit 103 (step A2).

Next, the feature representation extraction unit 103 inputs the group of the pairs of the representation and the feature value for each data to be analyzed from the feature value calculation unit 102 and extracts the representation having a large feature value for each data to be analyzed as the feature representation. For example, the feature representation extraction unit 103 extracts the representation whose feature value is equal to or greater than the predetermined threshold value, the representation whose feature value is in the top certain percentage, or the like as the representation having a large feature value. The feature representation extraction unit 103 outputs the list of the feature representation of each data to be analyzed that is extracted to the data-set-to-be-analyzed search unit 104, the feature representation coverage calculation unit 105, and a cost-of-analysis calculation unit 106 (step A3).

Next, the data-set-to-be-analyzed search unit 104 inputs the list of the feature representation of each data to be analyzed from the feature representation extraction unit 103 and generates a plurality of data sets to be analyzed including one or more data to be analyzed from the plurality of data to be analyzed which is a candidate for the target of analysis. The data-set-to-be-analyzed search unit 104 outputs the generated data set to be analyzed to the feature representation coverage calculation unit 105 and the cost-of-analysis estimation unit 106.

Next, the feature representation coverage calculation unit 105 inputs the list of the feature representation of each data to be analyzed from the feature representation extraction unit 103 and inputs the data set to be analyzed from the data-set-to-be-analyzed search unit 104. The feature representation coverage calculation unit 105 calculates the feature representation coverage to the data set to be analyzed from the list of the feature representation to all data to be analyzed and the list of the feature representation to the data set to be analyzed. The feature representation coverage calculation unit 105 outputs the calculated value to the data-set-to-be-analyzed search unit 104.

The cost-of-analysis estimation unit 106 inputs the list of the feature representation of each data to be analyzed from the feature representation extraction unit 103 and inputs the candidate for the data set to be analyzed from the data-set-to-be-analyzed search unit 104. The cost-of-analysis estimation unit 106 calculates the cost of analysis to the data set to be analyzed from the sum of the costs of analysis in the list of the feature representation to each data to be analyzed included in the data set to be analyzed. The cost-of-analysis estimation unit 106 outputs the calculated value to the data-set-to-be-analyzed search unit 104 (step A4). The cost-of-analysis estimation unit 106 can calculate the cost of analysis of the list of the feature representation by assuming that the cost of analysis is proportional to the number of the feature representations included in the list of the feature representation.

Next, the data-set-to-be-analyzed search unit 104 inputs the feature representation coverage to the data set to be analyzed from the feature representation coverage calculation unit 105 and inputs the cost of analysis to the data set to be analyzed from the cost-of-analysis estimation unit 106. The data-set-to-be-analyzed search unit 104 searches for the most suitable data set to be analyzed of which the feature representation coverage is high and the cost of analysis is low from the generated data set to be analyzed (step A5).

Finally, the data-set-to-be-analyzed search unit 104 outputs the feature representation extracted from the most suitable data set to be analyzed obtained in step A5 as a mining result to the output device 120 (step A6). After that, for example, the output device 120 displays the mining result outputted by the data-set-to-be-analyzed search unit 104 in a display unit.

Next, the effect of the exemplary embodiment will be described. In this exemplary embodiment, the data processing device, the input device, and the output device are included. Further, the data processing device includes the positive example group identification unit, the feature value calculation unit, the feature representation extraction unit, the data-set-to-be-analyzed search unit, the feature representation coverage calculation unit, and the cost-of-analysis estimation unit. The data processing device searches for the most suitable data set to be analyzed, of which the feature representation coverage that is extracted from a viewpoint of the analysis is high and the cost of analysis is low. The data processing device outputs the feature representation extracted from the data set to be analyzed that is searched for to the output device as the mining result.

A case in which when a plurality of data to be analyzed that is the candidate for the target of analysis exist and the target of analysis is narrowed down to one or a part of the data to be analyzed in advance, the feature representation cannot be sufficiently covered to the viewpoint of the analysis which is dynamically selected by the analyst is considered. Even in such case, in the exemplary embodiment, completeness of the feature representation can be sufficiently satisfied to the viewpoint of the analysis and a waste cost of analysis can be reduced as much as possible.

Next, the operation of the text mining system in this exemplary embodiment will be described by using a specific example. First, the operation in step A1 of FIG. 4 will be described.

The positive example group identification unit 101 inputs the axis of the analysis and the plurality of data to be analyzed from the input device 110. Here, a case in which an attribute value is given to each text of each data to be analyzed is considered. In this case, the analyst can set the axis of the analysis by designating a specific value with respect to this attribute value. Further, even if the attribute value is not given, the analyst can set the axis of the analysis by generating the attribute value from the text. For example, when the analyst performs an operation for designating the specific value with respect to the attribute value by using the input device 110, the input device 110 outputs the axis of the analysis based on the designated value to the positive example group identification unit 101 according to the analyst's operation. In the description described below, the representation that says “the analyst designates the predetermined value or the like” means that “the input device 110 inputs the predetermined value according to the operation of the analyst and designates it”.

As a specific example, a case in which a certain cosmetics sales company acquires the data to be analyzed in order to gather opinions of customers on various cosmetics products and integrally analyzes them is considered. This cosmetics sales company acquires the plurality of data to be analyzed by using various different means such as a call of a call center, a response log, an electronic mail, a bulletin board on the Web, questionnaires, and the like. Here, a case in which the analyst performs analysis with respect to the axis of the analysis, which is “feature in the description about the skin lotion related product that earns a low score by customers in their thirties”, is considered.

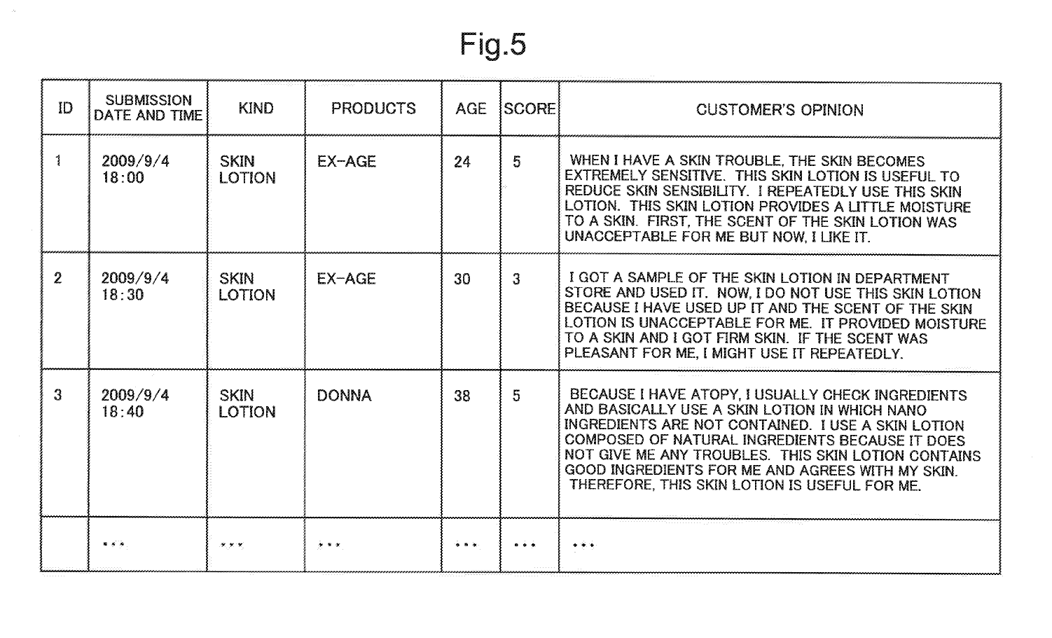

For example, a case in which in the plurality of data to be analyzed, the data to be analyzed acquired from the bulletin board A is obtained as the text group with an attribute value as shown in FIG. 5 is considered. In this case, specifically, the positive example with respect to the axis of the analysis designated by the analyst can be obtained by extracting a case example of which the condition of the attribute value, that is “type=“skin lotion”, age=30 to 39, and score=1 to 3” is satisfied. Accordingly, in the case examples shown in FIG. 5, the positive example group identification unit 101 extracts the case example satisfying the condition, of which ID is “2”, as the positive example. The positive example group identification unit 101 outputs the whole text group and the positive example group for each data to be analyzed that are extracted by such method to the feature value calculation unit 102.

Next, the operation in step A2 will be described. The feature value calculation unit 102 inputs the whole text group and the positive example group with respect to the viewpoint of the analysis of each data to be analyzed from the positive example group identification unit 101 and extracts the representation from the text.

As a specific example, when the feature value calculation unit 102 extracts an independent word obtained from the morphological analysis result as the representation, for example, the words of “scent”, “pleasant”, and “use” are extracted as the representation from a sentence that says “If the scent was pleasant for me, I might use it.”

For example, a case in which in one thousand four hundred and fifty two text groups of the data to be analyzed acquired from the bulletin board A, the word of “scent” appears 51 times and in three hundred and five positive example groups with respect to the viewpoint of the analysis, that is “type=“skin lotion”, age=30 to 39, and score=1 to 3”, the word of “scent” appears 34 times is considered. In this case, the feature value calculation unit 102 calculates the feature value from the statistical difference in appearance of them.

For example, when the chi-square distribution is used as the feature value, the feature value calculation unit 102 can calculate the feature value by using the following equations (1) to (3). The feature value calculation unit 102 can calculate the feature value by using the various measures with respect to the correlation such as Stochastic Complexity, Extended Stochastic Complexity, or the like in addition to the chi-square distribution as the feature value.

$$\begin{matrix}[ Mathematical formula 1 ] & \\ {x}^{2} = \frac{{N ( {O}_{11} - {E}_{11} )}^{2}}{{E}_{11} {E}_{22}} \\ where & Equation ( 1 ) \\ {E}_{11} = \frac{{R}_{1} {C}_{1}}{N} = \frac{( {O}_{11} + {O}_{12} ) \cdot ( {O}_{11} + {O}_{21} )}{N} & Equation ( 2 ) \\ {E}_{22} = \frac{{R}_{2} {C}_{2}}{N} = \frac{( {O}_{21} + {O}_{22} ) \cdot ( {O}_{12} + {O}_{22} )}{N} & Equation ( 3 )\end{matrix}$$

In the above-mentioned example of the word of “scent” in the data to be analyzed acquired from the bulletin board A, N=1452, O₁₁=34, O₁₂=51−34=17, O₂₁=305−34=271, and O₂₂=1452−305−51+34=1130. Therefore, the feature value calculation unit 102 calculates the value of the chi-square by using the equation (4) to the equation (6).

$$\begin{matrix}[ Mathematical formula 2 ] & \\ {E}_{11} = \frac{( 34 + 17 ) \cdot ( 34 + 271 )}{1452} = 10.713 & Equation ( 4 ) \\ {E}_{22} = \frac{( 271 + 1130 ) \cdot ( 17 + 1130 )}{1452} = 1106.8 & Equation ( 5 ) \\ {x}^{2} = \frac{1452 \cdot {( 34 - 10.713 )}^{2}}{10.713 \cdot 1106.8} = 66.407 & Equation ( 6 )\end{matrix}$$

Similarly, the feature value calculation unit 102 calculates the feature value to all representations extracted from the text group in the data to be analyzed acquired by the respective means. The feature value calculation unit 102 outputs a list of a combination of the representation and the feature value for each data to be analyzed to the feature representation extraction unit 103.

Next, the operation in step A3 will be described. The feature representation extraction unit 103 inputs the list of the combination of the representation and the feature value for each data to be analyzed from the feature value calculation unit 102 and extracts the representation whose feature value is large as the feature representation for each data to be analyzed.

The following method is used as a specific method for determining whether the feature value is large. For example, in the text mining system, the threshold value designated by the analyst may be set as the threshold value of the feature value that is commonly used for all data to be analyzed. As a result, the feature representation extraction unit 103 can extract the representation of which the feature value exceeds this threshold value as the feature representation. The analyst may designate an extraction rate of the feature representation. In this case, the feature representation extraction unit 103 can perform an extraction process by adjusting the threshold value of the feature value that is commonly used for all data to be analyzed so that the ratio of the total number of the feature representations that are extracted to the total number of the representations included in all data to be analyzed is equal to the designated extraction rate.

The feature representation extraction unit 103 outputs the list of the feature representation of each data to be analyzed that is extracted by such method to the data-set-to-be-analyzed search unit 104.

Next, the operation in step A4 will be described. The data-set-to-be-analyzed search unit 104 inputs the list of the feature representation of each data to be analyzed from the feature representation extraction unit 103. The data-set-to-be-analyzed search unit 104 generates the data set to be analyzed including one or more combinations of data to be analyzed from all data to be analyzed which is the candidate for the target of analysis with respect to all possible combinations.

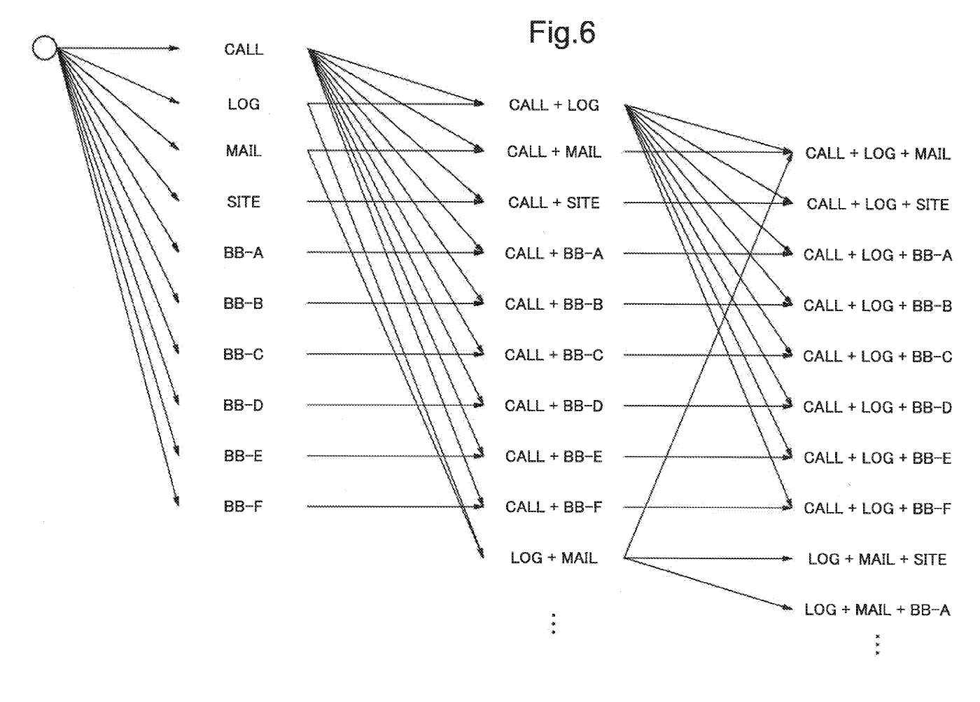

As a specific example, it is assumed that in total, ten of the data to be analyzed that are acquired by various different means such as a call of a call center, a response log, an electronic mail, a word-of-mouth site on the Web, a bulletin board, and questionnaires are expressed as “call”, “log”, “mail”, “site”, “BB-A”, “BB-B”, “BB-C”, “BB-D”, “BB-E”, and “BB-F”, respectively. Here, the expression of “BB-A” shows a bulletin board A. Similarly, the expressions of “BB-B”, “BB-C”, “BB-D”, “BB-E”, and “BB-F” show a bulletin board B, a bulletin board C, a bulletin board D, a bulletin board E, and a bulletin board F, respectively. The data-set-to-be-analyzed search unit 104 generates the data sets to be analyzed as shown in FIG. 6 as the possible combination of the data to be analyzed.

For example, it is shown that the data set to be analyzed of “call+log+mail” includes three data to be analyzed of “call”, “log”, and “mail”. Further, the data set to be analyzed of “call+log+mail” is linked from three different data sets to be analyzed of “call+log”, “call+mail”, and “log+mail” (an arrow shows a link between them). This shows a relationship that the data set to be analyzed of “call+log+mail” includes all three data to be analyzed of “call”, “log”, and “mail” that are included in three data sets to be analyzed.

Next, the feature representation coverage calculation unit 105 calculates the feature representation coverage to the data set to be analyzed from the list of the feature representation to all data to be analyzed and the list of the feature representation to the data set to be analyzed.

For example, the feature representation coverage calculation unit 105 can calculate the feature representation coverage to the data set to be analyzed of “call+log+mail” as a value obtained by dividing the number of different feature representations extracted from three data to be analyzed of “call”, “log”, and “mail” that are included in the data set to be analyzed of “call+log+mail” by the number of different feature representations extracted from all ten data to be analyzed. The number of different feature representations is the number of kind of feature representations.

Similarly, the cost-of-analysis estimation unit 106 calculates the cost of analysis to the data set to be analyzed from the sum of the costs of analysis in the list of the feature representation to each data to be analyzed included in the data set to be analyzed.

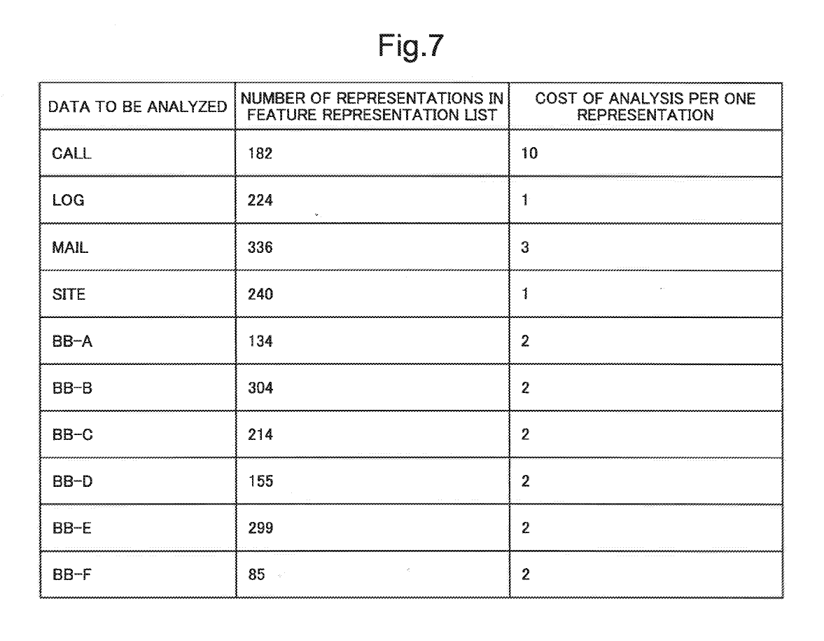

For example, the cost-of-analysis estimation unit 106 can calculate the cost of analysis to the data set to be analyzed of “call+log+mail” as the sum of the costs of analysis in the feature representation list which are extracted from three data to be analyzed of “call”, “log”, and “mail” that are included in the data set to be analyzed of “call+log+mail”. The cost-of-analysis estimation unit 106 can calculate the cost of analysis in the feature representation list that is extracted from each data to be analyzed by calculating for example, the product of “the number of representations in the feature representation list” and “the cost of analysis per one representation” for each data to be analyzed. Here, a case in which “the number of representations in the feature representation list” and “the cost of analysis per one representation” of each data to be analyzed are obtained as shown in FIG. 7 is considered. In this case, the cost-of-analysis estimation unit 106 can calculate the cost of analysis to the data set to be analyzed of “call+log+mail” by the sum of three products: the product of “the number of representations in the feature representation list” and “the cost of analysis per one representation” of the call target data of “call”, the product calculated by using the call target data of “log”, and the product calculated by using the call target data of “mail”. Namely, the cost of analysis can be calculated by the following calculation: 182×10+224×1+336×3=3102. Here, for example, “the cost of analysis per one representation” is set by the analyst in advance according to the source from which the data to be analyzed is obtained.

The coverage rate and the cost of analysis of the data set to be analyzed that are calculated by the feature representation coverage calculation unit 105 and the cost-of-analysis estimation unit 106 are outputted to the data-set-to-be-analyzed search unit 104, respectively.

Next, the operation in step A5 will be described. The data-set-to-be-analyzed search unit 104 searches for the most suitable data set to be analyzed of which the feature representation coverage is high and the cost of analysis is low based on the feature representation coverage and the cost of analysis to each data set to be analyzed that are calculated by the feature representation coverage calculation unit 105 and the cost-of-analysis estimation unit 106.

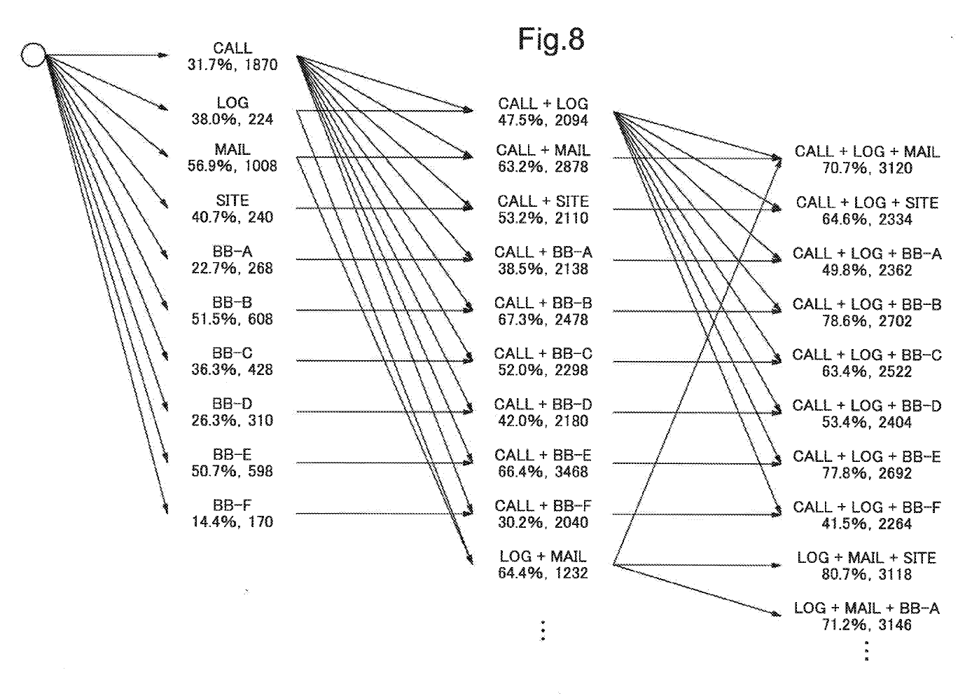

For example, a case in which the analyst designates the data set to be analyzed of which the feature representation coverage is equal to or greater than 70% and the cost of analysis is minimum as the most suitable data set to be analyzed is considered. In this case, the data-set-to-be-analyzed search unit 104 can obtain the most suitable data set to be analyzed by searching a network of the data set to be analyzed as shown in FIG. 8.

In an example shown in FIG. 8, the data shown under each data set to be analyzed indicate the feature representation coverage and the cost of analysis of the data set to be analyzed. In such network, the data-set-to-be-analyzed search unit 104 can search for the most suitable data set to be analyzed by following the arrows in order from a circle shown in the leftmost side of FIG. 8 that is a base point.

A case in which when the data-set-to-be-analyzed search unit 104 follows the arrows in order, it detects for example, the data set to be analyzed of “call+log+mail” shown in FIG. 8 of which the feature representation coverage exceeds the predetermined value of 70% is considered. In this case, the data set to be analyzed (for example, “call+log+mail+site” or the like) located on the right side of the data set to be analyzed of “call+log+mail” and linked from the data set to be analyzed of “call+log+mail” includes all the data to be analyzed included in the data set to be analyzed of “call+log+mail”. Therefore, the feature representation coverage of the data set to be analyzed that is located on the right side of the data set to be analyzed of “call+log+mail” and linked from the data set to be analyzed of “call+log+mail” is greater than the feature representation coverage of the data set to be analyzed of “call+log+mail”. Accordingly, the data-set-to-be-analyzed search unit 104 can determine that the feature representation coverage of the data set to be analyzed that is located on the right side of the data set to be analyzed of “call+log+mail” and linked from the data set to be analyzed of “call+log+mail” exceeds the predetermined value of 70%.

Further, the cost of analysis of the data set to be analyzed that is located on the right side of the data set to be analyzed of “call+log+mail” and linked from the data set to be analyzed of “call+log+mail” exceeds the cost of analysis of the data set to be analyzed of “call+log+mail”. Accordingly, the data-set-to-be-analyzed search unit 104 can determine that all data sets to be analyzed that are located on the right side of these data sets to be analyzed and linked from these data sets to be analyzed satisfy the condition of the feature representation coverage but does not satisfy the condition of the cost of analysis because it is larger than that of these data sets to be analyzed and whereby, the all data sets to be analyzed can not be selected as the most suitable data set to be analyzed. Therefore, the data-set-to-be-analyzed search unit 104 can easily determine that the all data sets to be analyzed can not be selected as the most suitable data set to be analyzed by following the arrows in order. (Further, in an implementation in which the feature representation coverage and the cost of analysis are evaluated in synchronization with a search process, the calculation of the feature representation coverage and the cost of analysis of the data set to be analyzed that does not correspond to the above-mentioned most suitable data set to be analyzed is not required). As a result of the above-mentioned process, the data-set-to-be-analyzed search unit 104 keeps the data sets to be analyzed of “call+log+mail”, “call+log+BB-B”, “call+log+BB-E”, “log+mail+site”, and “log+mail+BB-A” of which the feature representation coverage exceeds 70% as the candidate in a range shown in FIG. 8.

By performing such method, the data-set-to-be-analyzed search unit 104 follows all the arrows linking between the data sets to be analyzed and then detects the data set to be analyzed of which the cost of analysis is minimum in the candidates which satisfy the condition of the feature representation coverage as the most suitable data set to be analyzed. For example, the cost of analysis of the data set to be analyzed of “call+log+BB-E” is 2692 and minimum in the costs of analysis of the data sets to be analyzed of “call+log+mail”, “call+log+BB-B”, “call+log+BB-E”, “log+mail+site”, and “log+mail+BB-A”. Therefore, the data-set-to-be-analyzed search unit 104 determines that the data set to be analyzed of “call+log+BB-E” is the most suitable data set to be analyzed.

Finally, the operation of step A6 will be described. The data-set-to-be-analyzed search unit 104 outputs the feature representation extracted from the most suitable data set to be analyzed obtained in step A5 to the output device 120 as the mining result.

For example, when the data set to be analyzed of “call+log+BB-E” is selected as the most suitable data set to be analyzed, the data-set-to-be-analyzed search unit 104 extracts the feature representation list from three data to be analyzed of “call”, “log”, and “BB-E” included in the data set to be analyzed of “call+log+BB-E”. The data-set-to-be-analyzed search unit 104 outputs the extracted feature representation list to the output device 120 as the mining result. After that, for example, the output device 120 displays the mining result in the display unit.

According to the above mentioned description, a certain cosmetics sales company acquires a plurality of data to be analyzed by various different means such as a call of a call center, a response log, an electronic mail, a bulletin board on the Web, and questionnaires in order to gather opinions of customers on the various cosmetics products and can integrally analyze these data. Specifically, when the analyst performs analysis with respect to the axis of the analysis, which is “feature in the description about the skin lotion related product that earns a low score by customers in their thirties”, the data-set-to-be-analyzed search unit 104 may perform the following process. Namely, the data-set-to-be-analyzed search unit 104 selects the data set to be analyzed of “call+log+BB-E”, which has a minimum cost of analysis, which covers the feature representation of 70% or more from each data to be analyzed with respect to this axis of the analysis, and outputs the feature representation list thereof as the mining result. Therefore, the text mining system of the exemplary embodiment satisfies the predetermined feature representation coverage and can reduce the cost of analysis by approximately 2692/(1870+224+1008+240+268+608+428+310+598+170)=47% in comparison with a case in which all data to be analyzed are analyzed as the targets of the analysis.

Further, as another example, for example, the analyst can designate the data set to be analyzed of which the cost of analysis is 3000 or less and the feature representation coverage is maximum as the most suitable data set to be analyzed. Even in this case, the data-set-to-be-analyzed search unit 104 can obtain the most suitable data set to be analyzed by searching the network of the data set to be analyzed shown in FIG. 8 like the above-mentioned example.

Similarly, the data-set-to-be-analyzed search unit 104 can use a method of searching for the most suitable data set to be analyzed in which the arrows are followed in order from the circle shown in the leftmost side of FIG. 8 that is a base point. For example, a case in which the data-set-to-be-analyzed search unit 104 determines that the data set to be analyzed of which the cost of analysis exceeds 3000 does not correspond to the most suitable data set to be analyzed is considered. In this case, the cost of analysis of this data set to be analyzed and all data sets to be analyzed that are located on the right side of this data set to be analyzed and linked from this data set to be analyzed exceed 3000 and the condition is not satisfied. Therefore, the data-set-to-be-analyzed search unit 104 can determine that these data sets to be analyzed do not correspond to the most suitable data set to be analyzed.

After the data-set-to-be-analyzed search unit 104 follows all the arrows in order by such method, it determines the data set to be analyzed of which the feature representation coverage is maximum as the most suitable data set to be analyzed in the remaining candidates for the data set to be analyzed of which the cost of analysis is smaller than 3000. In a range shown in FIG. 8, the data set to be analyzed of “call+log+BB-B” has a maximum feature representation coverage of 78.6% in the data sets to be analyzed of which the cost of analysis is smaller than 3000. Therefore, the data-set-to-be-analyzed search unit 104 selects the data set to be analyzed of “call+log+BB-B” as the most suitable data set to be analyzed.

By the above mentioned method, in the this exemplary embodiment, even when the analyst sets the upper limit of the cost of analysis, the data set to be analyzed of which the feature representation coverage is maximum is selected and the feature representation list corresponding to this data set to be analyzed is outputted as the mining result. Accordingly, even when the cost of analysis is limited, the mining result which maximizes the efficiency of analysis can be outputted.

As mentioned above, the present invention includes means for solving the following problem. The text mining system according to the present invention includes the data processing device, the output device, and the input device. Further, the data processing device includes the positive example group identification unit, the feature value calculation unit, the feature representation extraction unit, the data-set-to-be-analyzed search unit, the feature representation coverage calculation unit, and the cost-of-analysis estimation unit. The data processing device searches for the most suitable data set to be analyzed based on the condition of the coverage and the cost of analysis of the feature representation with respect to the given viewpoint of the analysis and outputs the feature representation extracted from the most suitable data set to be analyzed as the mining result.

The text mining system adopts such configuration and searches for the data set to be analyzed of which the feature representation coverage of the feature representation list to the data set to be analyzed is high and the cost of analysis is low as the most suitable data to be analyzed. The text mining system can achieve the object of the present invention by outputting the feature representation extracted from the data set to be analyzed as the mining result.

The present invention has effects in which when a plurality of data to be analyzed are analyzed, even when these data are integrally analyzed, increase in cost of analysis performed by an analyst can be suppressed.

The reason is as follows. Namely, the text mining system searches for the data set to be analyzed of which the feature representation coverage is high and the cost of analysis is low from the plurality of data to be analyzed as the most suitable data set to be analyzed and outputs the mining result to the data set to be analyzed. Therefore, the text mining system can reduce the cost of analysis without having a large influence on the integrated mining result.

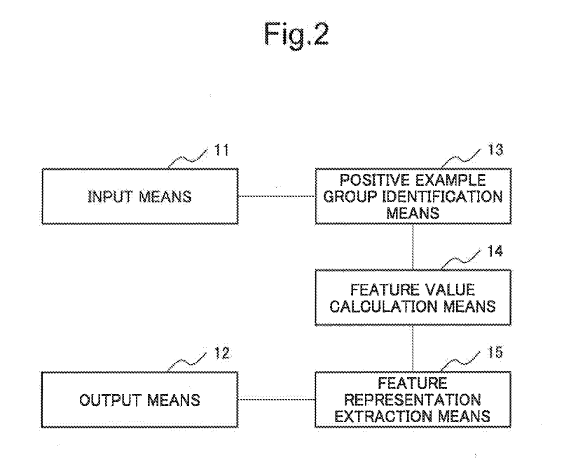

In the related technology, there is a case in which when the text mining is performed, a system in which first, the positive example group to the viewpoint of the analysis is identified from the text group and the text mining is performed by using the identified positive example group is used. An example of the text mining system in which the positive example group is identified and the text mining is performed will be described below. As shown in FIG. 2, this text mining system is composed of input means 11, output means 12, positive example group identification means 13, feature value calculation means 14, and feature representation extraction means 15.

The text mining system having such configuration operates as follows. Namely, when the input means 11 input the text group acquired from a certain channel and the viewpoint of the analysis, the positive example group identification means 13 identifies the positive example group to the viewpoint of the analysis in the text groups. Next, the feature value calculation means 14 calculate the feature value to the representation from the statistical difference in appearance between the whole text group and the positive example group to each representation in the text. Next, the feature representation extraction means 15 extract the representation having a large feature value as the feature representation. The output means output the feature representation extracted by the feature representation extraction means.

The system shown in FIG. 2 mentioned above has a problem in which when a plurality of data to be analyzed are analyzed, it is necessary to integrally analyze the plurality of data and the cost of analysis performed by the analyst remarkably increases.

The reason is as follows. A first reason is that the analyst has to perform a comparative analysis with respect to a combination of data to be analyzed in order to integrally analyze the plurality of data to be analyzed. Further, when the analyst performs the analysis by changing the axis of the analysis while performing trial and error, the feature representation list is updated with a change in the axis of the analysis. Therefore, the analyst has to perform the comparative analysis with respect to the combination of the above-mentioned analysis data for each change in the axis of the analysis. A second reason is that time and effort (it is also called as a cost of analysis) required for the entire analysis including trial-and-error of the axis of the analysis remarkably increases.

On the other hand, in the present invention, when a plurality of data to be analyzed is analyzed, even when the plurality of data to be analyzed are integrally analyzed, increase in cost of analysis performed by the analyst can be suppressed.

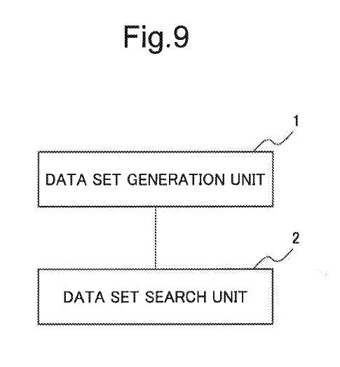

Next, a minimum configuration of the text mining system according to the present invention will be described. FIG. 9 is a block diagram showing an example of a minimum configuration of the text mining system. As shown in FIG. 9, the text mining system includes a data set generation unit 1 and a data set search unit 2 as a minimum component.

In the text mining system with a minimum configuration shown in FIG. 9, the data set generation unit 1 generates a plurality of data sets to be analyzed which are composed of one or more data to be analyzed that are extracted from a plurality of data to be analyzed collected by various different means. The data set search unit 2 searches for the data set to be analyzed of which the feature representation coverage is high and the cost of analysis is low in the plurality of data sets to be analyzed generated by the data set generation unit 1 as the most suitable data set to be analyzed. Further, the feature representation coverage is a degree of coverage of the feature representation group in all data to be analyzed in the feature representation group in the data set to be analyzed.

Accordingly, the text mining system with a minimum configuration can suppress increase in cost of analysis even when it integrally analyzes the plurality of data to be analyzed.

Further, in this exemplary embodiment, a characteristic configuration of the text mining system as shown in the following items (1) to (8) is described.

(1) The text mining system is characterized by comprising a data set generation unit (for example, it is realized by the data-set-to-be-analyzed search unit 104) which generates a plurality of data sets to be analyzed (for example, “call”+“log”+“mail”, or the like) that are composed of the data to be analyzed extracted from a plurality of data to be analyzed which are collected by various different means (for example, a call, a log, or the like) and a data set search unit (for example, it is realized by the data-set-to-be-analyzed search unit 104) which searches for the data set to be analyzed of which the feature representation coverage that is a degree of coverage of the feature representation group in all data to be analyzed in the feature representation group in the data set to be analyzed is high and the cost of analysis is low in the plurality of data sets to be analyzed generated by the data set generation unit as the most suitable data set to be analyzed.

(2) The text mining system may be configured so as to include a cost-of-analysis calculation unit (for example, it is realized by the cost-of-analysis estimation unit 106) which calculates the cost of analysis of the data to be analyzed as a value proportional to the number of the feature representations in the feature representation list to the data to be analyzed and calculates the cost of analysis of the data set to be analyzed by the sum of the costs of analysis of each data to be analyzed included in the data set to be analyzed.

(3) The text mining system may be configured so that the cost-of-analysis calculation unit calculates the cost of analysis in the feature representation list to the data to be analyzed by the product of the number of feature representations included in the feature representation list and the cost of analysis per the feature representation in the data to be analyzed.

(4) The text mining system may be configured so as to include a feature representation coverage calculation unit (for example, it is realized by the feature representation coverage calculation unit 105) which calculates the feature representation coverage as the ratio of the number of different feature representation groups in the data set to be analyzed to the number of different feature representation groups extracted from all of the plurality of data to be analyzed.

(5) The text mining system may be configured so that the data set search unit searches for the data set to be analyzed of which the feature representation coverage is maximum (for example, “call+log+BB-B” in a range in FIG. 8) in the data sets to be analyzed of which the cost of analysis does not exceed a value given beforehand (for example, 3000) as the most suitable data set to be analyzed.

(6) The text mining system may be configured so that, when a data set to be analyzed of which the cost of analysis exceeds the value given beforehand is obtained in the search of the most suitable data set to be analyzed, the data set search unit also determines an arbitrary data set to be analyzed including data to be analyzed that are all of the components of the obtained data set to be analyzed as the data set to be analyzed of which the cost of analysis exceeds the value given beforehand.

(7) The text mining system may be configured so that the data set search unit searches for the data set to be analyzed of which the cost of analysis is minimum (for example, “call+log+BB-E” in a range in FIG. 8) in the data sets to be analyzed of which the feature representation coverage exceeds the value given beforehand (for example, 70%) as the most suitable data set to be analyzed.

(8) The text mining system may be configured so that, when a data set to be analyzed of which the feature representation coverage exceeds the value given beforehand is obtained in the search of the most suitable data set to be analyzed, the data set search unit determines an arbitrary data set to be analyzed including data to be analyzed that are all of the components of the obtained data set to be analyzed as the data set to be analyzed of which the feature representation coverage exceeds the value given beforehand.

While the invention has been particularly shown and described with reference to preferred exemplary embodiments thereof, the invention is not limited to these embodiments. It is obvious that various changes in form and details may be made therein without departing from the spirit and scope of the present invention as defined by the claims.

This application is based upon and claims the benefit of priority from Japanese patent application No. 2009-286318, filed on Dec. 17, 2009, the disclosure of which is incorporated herein in its entirety by reference.

### INDUSTRIAL APPLICABILITY

The present invention can be applied to the usage in which the customer's request, the problem with the products and services, and the like are analyzed by integrally analyzing a plurality of data to be analyzed which are acquired by various different means such as a call in a contact center of a company, an electronic mail, a customer's bulletin board site (Web) about the products and services, questionnaires, and the like by using the text mining.

### EXPLANATION OF REFERENCE

1 data set generation unit

2 data set search unit

100 data processing device

101 positive example group identification unit

102 feature value calculation unit

103 feature representation extraction unit

104 data-set-to-be-analyzed search unit

105 feature representation coverage calculation unit

106 cost-of-analysis estimation unit

110 input device

120 output device

1. A text mining system comprising:
a data set generation unit which generates data set to be analyzed that includes data to be analyzed including text data; and a data set search unit which searches for a data set to be analyzed of which a feature representation coverage exceeds a value given beforehand, or a cost of analysis does not exceed a value given beforehand from data sets to be analyzed generated by the data set generation unit, wherein the feature representation coverage is the ratio of the number of feature representations included in a feature representation list which is a group of feature representations, which are representations satisfying predetermined conditions from text data within the data set to be analyzed, to the number of feature representations in all data to be analyzed, and the cost of analysis is defined on the basis of the number of feature representations included in the data set to be analyzed.

2. The text mining system according to claim 1 comprising a cost-of-analysis calculation unit which calculates the cost of analysis of the data to be analyzed as a value proportional to the number of the feature representations in the feature representation list to the data to be analyzed and calculates the cost of analysis of the data set to be analyzed by the sum of the costs of analysis of each data to be analyzed included in the data set to be analyzed.

3. The text mining system according to claim 2, wherein the cost-of-analysis calculation unit calculates the cost of analysis of the data to be analyzed by the product of the number of the feature representations in the feature representation list to the data to be analyzed and the cost of analysis per the feature representation in the data to be analyzed.

4. The text mining system according to claim 1, comprising a feature representation coverage calculation unit which calculates the feature representation coverage as the ratio of the number of different feature representation lists in the data set to be analyzed to the number of different feature representation lists extracted from all data to be analyzed.

5. The text mining system according to claim 1, wherein the data set search unit searches for the data set to be analyzed of which the feature representation coverage is maximum from the data sets to be analyzed of which the cost of analysis does not exceed a value given beforehand.

6. The text mining system according to claim 5, wherein the data set search unit determines that the cost of analysis exceeds the value given beforehand with respect to an arbitrary data set to be analyzed including all data to be analyzed included in the data set to be analyzed of which the cost of analysis exceeds the value given beforehand.

7. The text mining system according to claim 1, wherein the data set search unit searches for the data set to be analyzed of which the cost of analysis is minimum from the data sets to be analyzed of which the feature representation coverage exceeds the value given beforehand.

8. The text mining system according to claim 7, wherein the data set search unit determines that the feature representation coverage exceeds the value given beforehand with respect to an arbitrary data set to be analyzed including all data to be analyzed included in the data set to be analyzed of which the feature representation coverage exceeds the value given beforehand.

9. A text mining method comprising:
generating a data set to be analyzed including data to be analyzed including text data; and
searching for a data set to be analyzed of which a feature representation coverage exceeds a value given beforehand, or a cost of analysis does not exceed a value given beforehand from generated data sets to be analyzed, wherein the feature representation coverage is the ratio of the number of feature representations included in a feature representation list which is a group of feature representations, which are representations satisfying predetermined conditions from text data within the data set to be analyzed, to the number of feature representations in all data to be analyzed, and the cost of analysis is defined on the basis of the number of feature representations included in the data set to be analyzed.

10. A recording medium recording a program which causes a computer to execute:
a process which generates a data set to be analyzed including data to be analyzed including text data; and a process which searches for a data set to be analyzed of which a feature representation coverage exceeds a value given beforehand, or a cost of analysis does not exceed a value given beforehand from generated data sets to be analyzed, wherein the feature representation coverage is the ratio of the number of feature representations included in a feature representation list which is a group of feature representations, which are representations satisfying predetermined conditions from text data within the data set to be analyzed, to the number of feature representations in all data to be analyzed, and the cost of analysis is defined on the basis of the number of feature representations included in the data set to be analyzed.
